(19) United States
(12) Patent Application Publication
(10) Pub. No.: US 2024/0094482 A1
(43) Pub. Date: Mar. 21, 2024

(54) LIGHT GUIDES

(71) Applicant: Hewlett-Packard Development Company, L.P., Spring, TX (US)

(72) Inventors: Super Liao, Hsinchu (TW); Xiao Jun Zhu, Suzhou City (CN); Hai Tao Liu, Suzhou City (CN); Hong Chun Wang, Chongqing (CN)

(21) Appl. No.: 17/949,747

(22) Filed: Sep. 21, 2022

(51) Int. Cl. G02B 6/42

(52) U.S. Cl. CPC G02B 6/4206; G02B 6/42

(57) ABSTRACT

In some examples, an electronic device includes a light guide. In some examples, the light guide includes a facial side and a rear side. In some examples, the facial side includes a lens to focus incoming light. In some examples, the rear side includes exit features to guide outgoing light. In some examples, the electronic device includes an image sensor disposed behind the lens to capture the incoming light.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a block diagram illustrating an example of an electronic device;

FIG. 2 is a diagram illustrating an example of a display device in accordance with some of the techniques described herein;

FIG. 3 is an enlarged top-down cross-sectional exploded view of the diagram of the example of the display device taken across the line 3-3 in FIG. 2;

FIG. 4 is a flow diagram illustrating an example of a method for utilizing a lens of a light guide in accordance with some of the techniques described herein; and

FIG. 5 is a diagram illustrating an example of a laptop computer that includes a lens in accordance with some of the techniques described herein.

### DETAILED DESCRIPTION

An electronic device is a device that includes electronic circuitry. Examples of an electronic device may include a computer (e.g., laptop computer), a smartphone, a tablet computer, a mobile device, etc. Some electronic devices include a display device and an image sensor. A display device is a device to display light and/or an image(s). Examples of a display device may include a monitor, a display screen, a touchscreen, a laptop display, etc. An image sensor is electronic circuitry to sense and/or capture light (e.g., an image(s)). Examples of an image sensor may include a charge-coupled device (CCD) image sensor, a complementary metal oxide semiconductor (CMOS) image sensor, etc.

Some electronic devices (e.g., laptop computers, tablet devices, smartphones, etc.) may dispose a lens for an image sensor in a border (e.g., frame, rim, and/or bezel) of a display device. For instance, a laptop computer may include a display device and a lens above or below the display area. Disposing the lens in the border of the display device may result in a larger border size and/or may constrain a size of the display area. In some examples, a view angle of the image sensor may be limited depending on the lens design.

Some examples of the techniques described herein may dispose a lens in a light guide. Disposing a lens in a light guide may reduce a size of a border of a display device and/or may allow an increase in display area. In some examples, disposing a lens in a light guide may allow enlarging a view angle, may provide manufacturing cost reduction, and/or may reduce optical aberration from a lens. For instance, optical aberration from a lens (e.g., aspheric lens) on a light guide may be reduced in some examples of the techniques described herein.

Throughout the drawings, similar reference numbers may designate similar or identical elements. When an element is referred to without a reference number, this may refer to the element generally, with or without limitation to any particular drawing or figure. In some examples, the drawings are not to scale, and the size of some parts may be exaggerated to more clearly illustrate the example shown. Moreover, the drawings provide examples in accordance with the description. However, the description is not limited to the examples provided in the drawings.

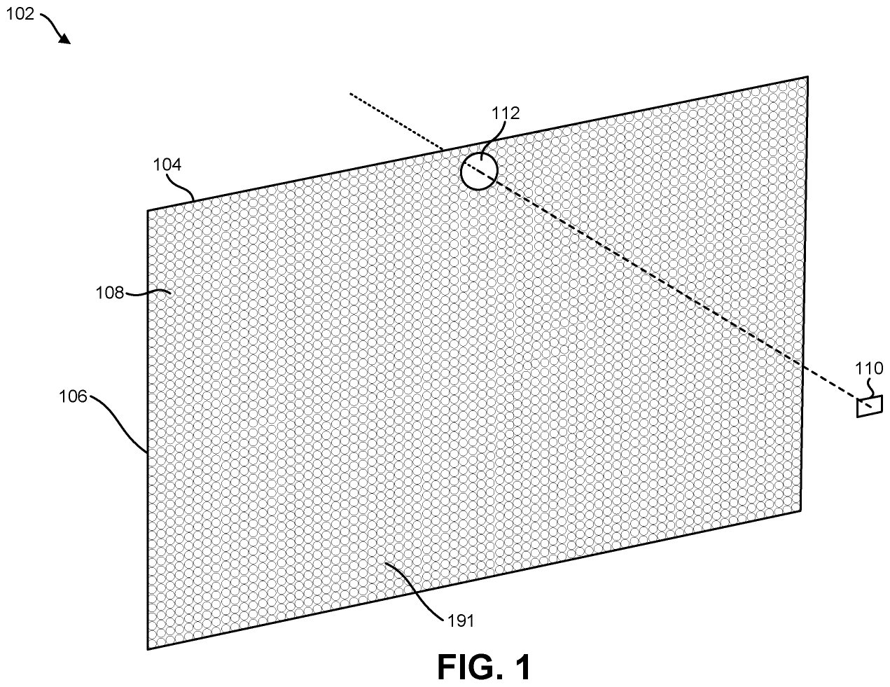

FIG. 1 is a block diagram illustrating an example of an electronic device 102. In some examples, the electronic device 102 may include a light guide 104, an image sensor 110, and/or a lens 112. FIG. 1 illustrates a rear perspective view of the light guide 104 exploded from the image sensor 110. A light guide is a structure to guide and/or conduct light. For instance, a light guide may be fabricated from a transparent and/or semi-transparent material (e.g., plastic, glass, acrylic resin, epoxy, etc.). In some examples, a light guide may be structured to exhibit total internal reflection for light in the light guide (e.g., traversing the light guide) in an angular range. In the example of FIG. 1, the light guide 104 is rectangularly shaped. The light guide 104 includes four edges (e.g., a top edge, bottom edge, left edge, and right edge), a facial side 106, and a rear side 191. In some examples, the light guide 104 may be shaped as a rectangular sheet and/or rectangular panel.

In some examples, the electronic device 102 may include a light source to provide light to the light guide 104. For instance, the electronic device 102 may include a light emitting diode (LED) (not shown in FIG. 1) to illuminate the light guide 104. In some examples, an LED(s) may be disposed at an edge of the light guide 104. For instance, the electronic device 102 may include a set of LEDs disposed at an edge(s) (e.g., top edge, bottom edge, left edge, and/or right edge) of the light guide 104. In some examples, the electronic device 102 may include an LED(s) disposed behind the light guide 104.

In some examples, a light guide may include an exit feature. An exit feature is a structure that allows light to exit a light guide. For instance, the rear side 191 may include exit features 108 to guide outgoing light. In some examples, the exit features 108 may guide (e.g., modify, disrupt, etc.) the internal reflection of the light guide 104 to pass light from the inside of the light guide 104 through the facial side 106. Examples of an exit feature(s) may include a micro-structure(s) (e.g., structure(s) at a microscopic scale), a bump(s), a dome(s), a variation(s) from planar geometry, a polyhedral shape(s), and/or a protrusion(s), etc. In some examples, the light guide 104 may not include an exit feature(s) on the facial side 106 of the light guide 104. For instance, the exit features 108 may be disposed on the rear side 191 to protect an optical film (e.g., to reduce and/or avoid scratching a display panel).

The light guide 104 may include a lens 112. The lens 112 may be disposed to focus incoming light. In some examples, the facial side 106 may include the lens 112 to focus incoming light. The lens 112 may be disposed to refract (e.g., focus) light traveling into the lens 112 (e.g., light from an environment towards the facial side 106 of the light guide 104). For instance, the lens 112 may refract (e.g., focus) the incoming light towards the image sensor 110. In some examples, the lens 112 may be disposed on the facial side 106, through the light guide 104, and/or on the rear side 191. In some examples, the lens 112 is fabricated with the same material as the light guide 104. For instance, the light guide 104 and the lens 112 may be fabricated from plastic (e.g., polycarbonate). In some examples, the lens 112 may be fabricated with the light guide 104. For instance, the light guide 104 may be manufactured, molded, and/or formed as part of the light guide 104. In some examples, the lens 112 may be fabricated with a different material from that of the light guide 104. For instance, the lens 112 may be glass and the light guide 104 may be plastic (e.g., polycarbonate). In some examples, the lens 112 may be monolithically formed with the light guide 104.

In some examples, the lens 112 may conduct light through the light guide 104 (e.g., through a portion of the light guide 104). For instance, the lens 112 may be transparent to light passing through the light guide 104 (e.g., reflecting in the light guide 104). In some examples, the lens 112 may conduct outgoing light. For instance, light in the light guide 104 may pass through and/or out of the lens 112. In some examples, an opaque or semi-opaque barrier may be disposed in the light guide 104 (e.g., as part of the light guide 104 and/or as part of the lens 112) to block light in the light guide 104 from entering the lens 112. For instance, an opaque or semi-opaque ring may block light transmission between the lens 112 and the light guide 104.

Examples of the lens 112 may include a wide-angle (e.g., fisheye) lens, a medium lens, or a telephoto lens. In some examples, a wide-angle lens may provide a field of view that is greater than 60 degrees, a medium lens may provide a field of view in a range of 25-60 degrees, or a telephoto lens may provide a field of view that is less than 25 degrees. In some examples, the lens 112 may be an aspheric lens (e.g., a lens with a non-spherical curvature). For instance, the lens 112 may have a surface curvature that is greater than the curvature of a spherical lens or that is less than the curvature of a spherical lens. In some examples, an aspheric lens may have a surface profile (e.g., sag) in accordance with Equation (1):

$$Z ( s ) = \frac{C {s}^{2}}{1 + \sqrt{1 - ( 1 + k ) {C}^{2} {s}^{2}}} + {A}_{4} {s}^{4} + {A}_{6} {s}^{6} + {A}_{8} {s}^{8} + … \qquad ( 1 )$$

In Equation (1), Z is the sag of a surface parallel to the optical axis, s is a radial distance from the optical axis, C is the curvature (e.g., inverse of radius), k is a conic constant, and A₄, A₆, and A₈, are 4th, 6th, and 8th order aspheric constants. In some examples, a lens radius may be in the range of 10 millimeters (mm)<R<1000 mm.

In some examples, the lens 112 may be a wide-angle lens. In some examples, the lens 112 may be a spherical lens (e.g., a lens with a spherical curvature).

In some examples, the electronic device 102 may include a second lens (not shown in FIG. 1) disposed between the image sensor 110 and the lens 112. In some examples, the second lens may have a second field of view that is different from a field of view of the lens 112. For instance, the field of view of the lens 112 may be larger (e.g., may have a greater angular range) than the second field of view of the second lens.

The image sensor 110 may be a device to sense and/or capture data (e.g., image information, an image stream, video stream, etc.). Some examples of the image sensor 110 may include an optical (e.g., visible spectrum) image sensor, millimeter wave sensor, time-of-flight (TOF) sensor, red-green-blue (RGB) sensor, infrared (IR) sensor, depth sensor, etc., or a combination thereof. The image sensor 110 may be disposed to capture the incoming light. In some examples, the image sensor 110 may be a sensor to capture incoming light in the visual spectrum. For instance, the image sensor 110 may be a CCD image sensor and/or a CMOS image sensor. In some examples, the image sensor 110 may be a sensor to capture incoming light in another spectrum (e.g., infrared). For instance, the image sensor 110 may be (and/or may be included in) a web cam, camera, millimeter wave sensor, etc. In some examples, the image sensor 110 may capture the incoming light as data, an image(s), and/or video frame(s), etc. For instance, the data may include visual information, depth information, IR sensing information, TOF information, or a combination thereof. In some examples, the image sensor 110 may be coupled to another circuitry(ies) to receive, process, and/or store data representing the captured light from the image sensor 110. For instance, the image sensor 110 may capture video for a video conference, broadcast, recording, etc.

In some examples, the electronic device 102 may include a display panel (not shown in FIG. 1) disposed in front of the facial side 106 of the light guide 104. A display panel is a device to produce an image. Examples of a display panel may include a liquid crystal display (LCD) panel, e-ink panel, mini-LED panel, micro-LED panel, quantum-dot LED (QLED) panel, etc. For instance, the display panel may include liquid crystal cells and transistors to form an image by controlling a pixel(s). In some examples, the display panel may include a polarizing layer(s). The light guide 104 may provide a backlight for the display panel.

In some examples, the display panel may include an opening aligned with the lens 112. For instance, the display panel may include an elliptical (e.g., circular) opening or other shaped opening to allow incoming light to pass through the display panel and enter the lens 112. In some examples, the lens 112 may be disposed (e.g., partially disposed) in the opening. For instance, a front curvature of the lens 112 may be disposed in the opening (e.g., recessed in the opening). In some examples, the lens 112 (e.g., a front curvature of the lens 112) may protrude through the opening.

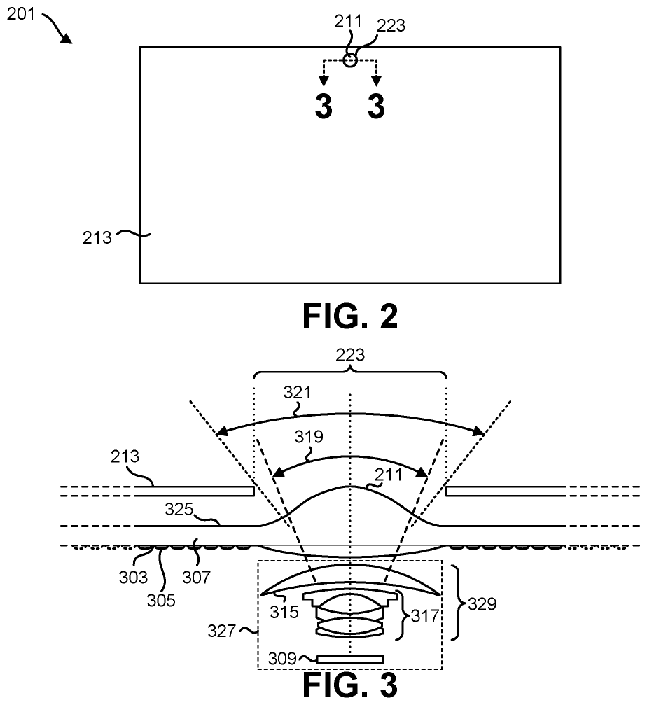

FIG. 2 is a diagram illustrating an example of a display device 201 in accordance with some of the techniques described herein. FIG. 3 is an enlarged top-down cross-sectional exploded view of the diagram of the example of the display device 201 taken across the line 3-3 in FIG. 2. FIG. 2 and FIG. 3 are described together. The display device 201 may be an example of the display device(s) described in relation to FIG. 1. A component(s), element(s), and/or aspect(s) described in FIG. 2 and/or FIG. 3 may be an example of a component(s), element(s), and/or aspect(s) described in FIG. 1.

The display device 201 may include a display panel 213. The display panel 213 may include an opening 223. The display device 201 may include a light guide 307 disposed behind the display panel 213. While the display panel 213 is illustrated with an exploded view, the display panel 213 may be disposed near (e.g., on, in contact with, etc.) the light guide 307. In some examples, the light guide 307 may be an example of the light guide 104 described in relation to FIG. 1.

The light guide 307 may include a facial side 325 and/or a rear side 303. The facial side 325 may include a lens 211. The lens 211 may be aligned with the opening 223. The lens 211 may focus incoming light (e.g., light from the environment and/or from the exterior of the display device 201). In some examples, the lens 211 may include a protrusion on (or from) the facial side 325 and/or a protrusion on (or from) the rear side 303. For instance, the lens 211 may include a first curvature that protrudes from a surface (e.g., level, plane, etc.) of the facial side 325 and/or a second curvature that protrudes from a surface (e.g., level, plane, etc.) of the rear side 303. In some examples, the first curvature may be different from the second curvature. In some examples, the first curvature may be greater than the second curvature. For instance, the first curvature may include a greater slope than a slope of the second curvature. In some examples, the first curvature may protrude from the surface of the facial side 325 to a greater distance than the second curvature may protrude from the surface of the rear side 303.

In some examples, the rear side 303 may include exit features 305 to guide outgoing light to the display panel 213. For instance, light in the light guide 307 (that is supplied by a light source, such as an LED, for example) may be guided by the exit features 305 toward and/or through the display panel 213. The light may provide backlight to the display panel 213.

The display device 201 may include an image sensor 309. The image sensor 309 may be disposed behind the lens 211 to capture the incoming light.

In some examples, the display device 201 may include a second lens 315. The second lens 315 may be disposed between the image sensor 309 and the lens 211. For instance, the second lens 315 may be disposed on and/or behind the rear side 303 (e.g., back side) of the light guide 307. In some examples, the lens 211 is an aspheric lens. The lens 211 may have a first field of view 321. The second lens 315 may have a second field of view 319 that is different from the first field of view 321. For instance, the lens 211 may be a wide-angle lens and the second lens 315 may be a medium lens. In some examples, the lens 211 may expand the field of view relative to the second lens 315. The lens 211 may capture a greater angular range of light, which may be provided to the second lens 315 and to the image sensor 309. For instance, the view angle of the second lens 315 may be smaller than a view angle of the second lens 315 in combination with the lens 211. In some examples, the lens 211 may refract more light into the second lens 315, which may result in a wider view angle. In some examples, utilizing the lens 211 of the light guide 307 may reduce manufacturing costs. For instance, the lens 211 may be less expensive to manufacture than a separate wide angle lens and/or camera.

In some examples, the second lens 315 may be a lens that is integrated with the image sensor 309. For instance, the second lens 315 and the image sensor 309 may be included in a camera unit 327. The camera unit 327 may be a structure (e.g., module, package, component, off-the-shelf (OTS) component, etc.) that includes the second lens 315 and the image sensor 309. For instance, the second lens 315 and/or the camera unit 327 may be separate from the light guide 307. In some examples, the lens 211 and the second lens 315 may not be included in a same lens package. In some examples, a portion of the lens 211 on the rear side 303 may have a convex curvature that curves in a different direction from a convex curvature of the second lens 315 (e.g., opposite directions).

In some examples, the second lens 315 may be included in a lens unit 329. The lens unit 329 is a structure that includes a lens (e.g., second lens 315, front lens, etc.) and a lens element(s) 317. A lens element is a structure (e.g., transparent structure, subordinate lens, etc.) to refract light in conjunction with a front lens. In some examples, a lens element may be utilized to adjust for (e.g., compensate for, ameliorate, and/or enhance) a characteristic(s) of a front lens. For instance, the lens element(s) 317 may compensate for a distortion(s) and/or optical aberration(s) of the second lens 315. In some examples, the lens unit 329 (e.g., the second lens 315 and the lens element(s) 317) may be a compound lens. In some examples, the lens 211 may not be included in the lens unit 329 (e.g., may not be included in a compound lens of the second lens 315). In some examples, the lens element(s) 317 may include a concave lens to cause light rays to diverge onto the image sensor 309. For instance, a point of convergence may occur in the lens element(s) 317, which may spread the light onto the image sensor 309. A “second lens” as referred to herein may be included a lens unit and/or compound lens in some examples. In some examples, a lens of a light guide may not be included in a compound lens.

In some examples, the second lens 315 and the lens element(s) 317 may be packaged and/or integrated (e.g., manufactured) together in the camera unit 327. For instance, the second lens 315, the lens element(s) 317, and/or the image sensor 309 may be included in a camera (e.g., a separate camera disposed behind the light guide 307). In some examples, the lens element(s) 317 may be utilized to refract light from the second lens 315 onto the image sensor 309.

In some examples, the display device 213 may be coupled to (and/or included in) a computing device. The image sensor 309 may capture an image (e.g., series of images, video stream, etc.) of a scene. For instance, the image sensor 309 may capture video for a video conference, broadcast, recording, etc.

In some examples, the computing device may include memory. The memory may be an electronic storage device, magnetic storage device, optical storage device, other physical storage device, or a combination thereof that contains or stores electronic data (e.g., information, instructions, or a combination thereof). In some examples, the memory may be, for example, Random Access Memory (RAM), Electrically Erasable Programmable Read-Only Memory (EEPROM), a storage device, an optical disc, the like, or a combination thereof. In some examples, the memory may be volatile or non-volatile memory, such as Dynamic Random Access Memory (DRAM), EEPROM, magnetoresistive random-access memory (MRAM), phase change RAM (PCRAM), memristor, flash memory, the like, or a combination thereof. In some examples, the memory may be a non-transitory tangible machine-readable or computer-readable storage medium, where the term “non-transitory” does not encompass transitory propagating signals. In some examples, the memory may include multiple devices (e.g., a RAM card and a solid-state drive (SSD)).

In some examples, the computing device may include a processor. The processor may be electronic circuitry to process an image(s) (e.g., perform an operation on a video stream). In some examples, the processor may be logic circuitry to perform object detection, object tracking, feature point detection, motion estimation, etc., or a combination thereof. In some examples, the processor may be a semiconductor-based microprocessor, field-programmable gate array (FPGA), an application-specific integrated circuit (ASIC), other hardware device, or a combination thereof suitable for retrieval and execution of instructions stored in the memory. The processor may execute instructions stored in the memory. In some examples, the processor may include electronic circuitry that includes electronic components for performing an operation or operations described herein. In some examples, the processor may perform one, some, or all of the aspects, operations, elements, etc., described in one, some, or all of FIGS. 1-4.

In some examples, the image sensor 309 may be couped to a communication interface. The image sensor 309 may provide data to the communication interface to send the data to the processor. The processor may receive an image (e.g., image sensor stream, video stream, etc.). For instance, the processor may receive an image from the image sensor 309. For instance, the processor may receive an image stream via a wired or wireless communication interface (e.g., Mobile Industry Processor Interface (MIPI), MIPI Display Serial Interface (MIPI DSI), Universal Serial Bus (USB) port, Ethernet port, Bluetooth receiver, etc.).

Some examples of the processor may include a general-purpose processor, central processing unit (CPU), a graphics processing unit (GPU), and image processor, or a combination thereof. In some examples, the processor may be an application processor. In some examples, the processor may perform an operation based on the image(s) provided by the image sensor 309.

In some examples, the computing device may be a laptop computer, where the processor is disposed in a display panel housing or a body of the laptop computer. The display panel housing may house the image sensor 309 (e.g., camera), light guide 307, and/or display panel 213. In some examples, the data from the image sensor 309 (e.g., video) may be provided to an application (e.g., video conference application, etc.) executed by the processor. In some examples, the data from the image sensor 309 may be stored in memory. In some examples, the data from the image sensor 309 may be sent to another device (e.g., server, computing device, smartphone, etc.).

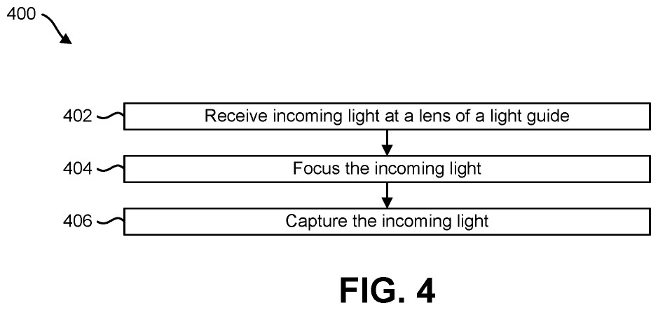

FIG. 4 is a flow diagram illustrating an example of a method 400 for utilizing a lens of a light guide in accordance with some of the techniques described herein. In some examples, the method 400 or a method 400 element(s) may be performed by an electronic device or apparatus (e.g., electronic device 102, display device 201, laptop computer, smartphone, tablet device, etc.). For example, the method 400 may be performed by the electronic device 102 described in FIG. 1 or the display device 201 described in FIGS. 2-3.

The method 400 may include receiving 402 incoming light at a lens through an opening in a display panel. The lens may be disposed on a facial side of a light guide. In some examples, receiving 402 incoming light may be performed as described in FIG. 1, FIG. 2, and/or FIG. 3.

The method 400 may include focusing 404, by the lens, the incoming light. In some examples, focusing 404 the incoming light may be performed as described in FIG. 1, FIG. 2, and/or FIG. 3.

The method 400 may include capturing 406 the incoming light by an image sensor disposed behind the lens. In some examples, capturing 406 the incoming light may be performed as described in FIG. 1, FIG. 2, and/or FIG. 3. In some examples, the method 400 may include focusing the incoming light by a second lens disposed between the lens and the image sensor. In some examples, focusing the incoming light by a second lens may be performed as described in FIG. 1, FIG. 2, and/or FIG. 3.

In some examples, the method 400 may include providing, by the light guide, outgoing light to the display panel. In some examples, providing the outgoing light may be performed as described in FIG. 1, FIG. 2, and/or FIG. 3. In some examples, an operation(s) of the method 400 may be omitted and/or combined.

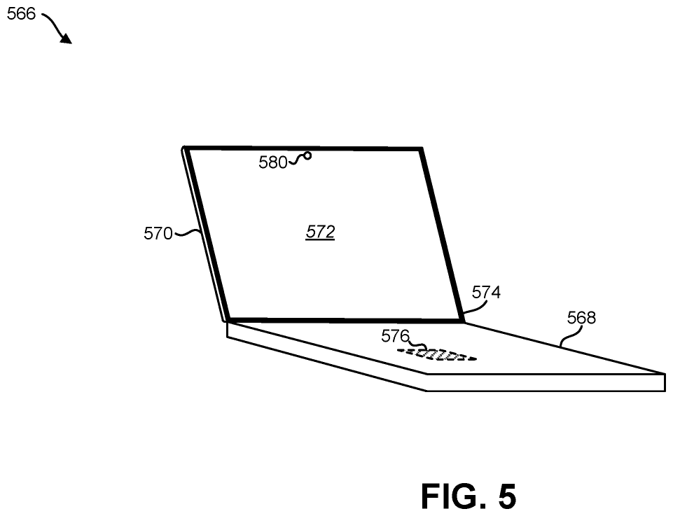

FIG. 5 is a diagram illustrating an example of a laptop computer 566 that includes a lens 580 in accordance with some of the techniques described herein. In some examples, the laptop computer 566 may be an example of the electronic device 102 described in FIG. 1 and/or the display device 201 described in FIGS. 2-3. In this example, the laptop computer 566 includes a body 568 and a display panel housing 570. In some examples, the display panel housing 570 may be rotatably coupled to the body 568 with a hinge 574, which may allow the display panel housing 570 to rotate into contact with the body 568 when closing the laptop computer 566.

The body 568 may house a component(s). For example, the body 568 may house a processor 576. The processor 576 may be a CPU or application processor. Examples of other components that may be housed in the body 568 may include memory or storage (e.g., RAM, solid state drive (SSD), etc.), a keyboard, motherboard, port(s), etc.

The display panel housing 570 may house a component(s). For example, the display panel housing 570 may house a display panel 572 and a lens 580. In some examples, the lens 580 may be included in a light guide in accordance with some of the techniques described herein. The lens 580 may provide incoming light to a camera (e.g., image sensor and/or lens(es)) disposed behind the lens 380. The camera may be coupled to the processor 576 via an interface and/or electronic link. The processor 576 may receive data (e.g., an image(s), a video stream, etc.) from the camera 580. The processor 576 may process the data to display the data on the display panel 572, to store the data, and/or to communicate the data (e.g., send the data to another device).

In the example of FIG. 5, the lens 580 is disposed in the display area of the display panel 572. In some examples, a lens (e.g., a lens of the light guide) may be disposed partially in the display area and partially in a border (e.g., frame, rim, bezel, etc.) area.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

What is claimed is:

1. An electronic device, comprising:
a light guide comprising a facial side and a rear side, wherein the facial side includes a lens to focus incoming light, and wherein the rear side includes exit features to guide outgoing light; and
an image sensor disposed behind the lens to capture the incoming light.

2. The electronic device of claim 1, wherein the lens is an aspheric lens.

3. The electronic device of claim 1, wherein the lens is a wide-angle lens.

4. The electronic device of claim 1, further comprising a second lens disposed between the image sensor and the lens, wherein the second lens has a second field of view that is different from a field of view of the lens.

5. The electronic device of claim 4, wherein the field of view of the lens is larger than the second field of view of the second lens.

6. The electronic device of claim 1, further comprising a light emitting diode (LED) to illuminate the light guide.

7. The electronic device of claim 6, wherein the LED is disposed at an edge of the light guide.

8. The electronic device of claim 1, further comprising a display panel disposed in front of the facial side of the light guide.

9. The electronic device of claim 8, wherein the display panel comprises an opening aligned with the lens.

10. A display device, comprising:
a display panel comprising an opening;
a light guide disposed behind the display panel, wherein the light guide comprises a facial side and a rear side, wherein the facial side includes a lens aligned with the opening to focus incoming light, and wherein the rear side includes exit features to guide outgoing light to the display panel; and
an image sensor disposed behind the lens to capture the incoming light.

11. The display device of claim 10, further comprising a second lens disposed between the image sensor and the lens.

12. The display device of claim 11, wherein the lens is an aspheric lens with a first field of view, and wherein the second lens has a second field of view that is different from the first field of view.

13. A method, comprising:
receiving incoming light at a lens through an opening in a display panel, wherein the lens is disposed on a facial side of a light guide;
focusing, by the lens, the incoming light; and
capturing the incoming light by an image sensor disposed behind the lens.

14. The method of claim 13, further comprising providing, by the light guide, outgoing light to the display panel.

15. The method of claim 13, further comprising focusing the incoming light by a second lens disposed between the lens and the image sensor.
